(19) United States
(12) Patent Application Publication
(10) Pub. No.: US 2008/0179845 A1
(43) Pub. Date: Jul. 31, 2008

(54) Method of transporting discrete articles in containers

(76) Inventors: Karl Krewenka, Palatine, IL (US); Mariann Gullo-Krewenka, Palatine, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/699,122

(22) Filed: Jan. 29, 2007

(51) Int. Cl. B62B 1/00

(52) U.S. Cl. 280/47.24

(57) ABSTRACT

A method of transporting articles including the steps of: providing a cart; placing at least one article in a container/bag having at least one downwardly facing edge; placing the container/bag with the at least one article therein in a hanging position on the cart; and applying a moving force to the frame to reposition the cart with the container/bag thereon. The step of providing a cart involves providing a frame with a top, a bottom, a wheel assembly on the frame and having at least one wheel that can be rolled against an underlying surface, and a hanging assembly. The container/bag with the at least one article therein is suspended on the hanging assembly above the underlying surface. The moving force applied to the frame causes the at least one wheel to roll against the underlying surface.

### BACKGROUND OF THE INVENTION

1. Field of the Invention

This invention relates to wheeled carts and, more particularly, to a method of transporting discrete articles in containers using such a cart.

2. Background Art

Modern shopping malls are configured to allow shoppers to walk from one store to the next and progressively accumulate purchases. To facilitate this, containers/bags are offered to the consumers, each into which one or a plurality of discrete articles can be placed. The containers/bags may be made from paper or plastic and are commonly provided with some handle structure that can be gripped in the hand of a user. For example, plastic bags are commonly made with a cutout into which a user's fingers can be directed so as to surround a length of the plastic in a gripping fashion. Paper bags may be equipped with paper, plastic, or string handles for this same purpose.

Consumers are allowed to grasp handles on a number of such containers/bags with each hand and transport them relatively comfortably with the arm(s) in a lowered position. There comes a point when the number of purchases makes it impractical to continue to shop. The accumulation of containers/bags may become too heavy or so bulky as to interfere with further enjoyable shopping. This situation normally leads to one of two events. The shopper may end up shopping in stages, accumulating containers/bags to a certain extent and then returning them to a parked vehicle, whereupon the shopping is resumed. Alternatively, the consumer may call off the shopping trip, to be continued at another time. The former represents a significant inconvenience, particularly when cars are parked distant from the last visited store. The latter may cause consumers to forego purchases that would otherwise be made had they been able to continue shopping in a single trip.

Aside from the problem of ultimately having to transport the container/bags home or to a vehicle, during the shopping process, the consumer is required to repeatedly place the container/bags down to allow inspection of other articles for potential purchase. By repeatedly putting the containers/bags down and elevating them, the user taxes his/her knees, back, neck, shoulders, and hands. This detracts from the shopping experience and could even lead to an injury. Also, there is the risk that when the bags are put down and elevated they may be reoriented in a manner that articles therein may fall out. Thus, one contends with the problem of re-packing the containers/bags and also of risking loss of articles.

Additionally, aside from carrying the container/bags, the consumer generally has on his/her person purses, cell phones, drinks, etc. The consumer must devise ways to also hold all of these articles in a comfortable manner that allows a continuing enjoyable shopping experience.

It is known to use portable and collapsible shopping carts to store and transport a number of containers/bags. The most common construction utilizes a wire basket with a relatively large wheel base and an integrally formed, U-shaped handle that opens downwardly and/or rearwardly with respect to a travel direction. The basket defines an upwardly opening receptacle into which the containers/bags and/or loose articles can be placed for storage. While this type of cart allows a user to potentially transport a large number of container/bags, this cart construction has a number of drawbacks.

First of all, the cart normally has a fixed width and is collapsible to reduce its dimensions only in a fore-and-aft direction. The width is generally approximately equal to the dimension of the wheel base, which may be relatively large to afford stability in use. If the user wishes to transport the empty cart, it is either carried in an elevated position or rolled over an underlying surface. It may be inconvenient or impractical to navigate the cart within crowds and in relatively narrow shopping aisles by rolling the cart. The same problem exists with the cart in an operative state in which the basket is configured to its largest volume.

By reason of its size, the cart also may be intrusive in a storage state within a vehicle and/or in a user's home.

The wire basket also has some inherent drawbacks. By reason of the fact that the-containers/bags are deposited in the upwardly opening receptacle, they may reconfigure, as a result of which the contents thereof may potentially shift and escape not only from a container/bag, but from the basket through openings in a mesh material normally bounding the basket container.

The configuration of these carts is such that items must be stacked, one upon the other. In the event items are fragile, they are prone to being broken or damaged.

Further, one or more large items may alone fill the receptacle, in which event additional items may have to be individually carried by hand. If a single large item does not fit in the receptacle, the user is required to separately transport the cart and the item.

This type of cart normally is designed to be pivotable about the wheel axis between stored and operative states. In the former state, the cart pivots under the weight of the contents in a rearward direction. The user is required to grasp the operating handle, typically with both hands, and pivot the entire cart around the wheel axis in a forward direction before the cart can be moved. Depending upon the distribution of weight within the basket container, this pivoting action may be awkward or difficult to effect.

Further, in light of the relatively large wheel base, the cart, particularly in a loaded state, may be difficult to maneuver in tight spaces and within crowds. A turning radius may be sufficiently large that a user may have to steer the cart by lifting or sliding it, rather than by merely rolling the same.

This type of cart is normally made from metal components, including formed wire of relatively small gauge. Metal components are prone to rusting. Additionally, the wire components are prone to being bent or broken and also present sharp edges that may injure a user and/or hang up on his/her clothing. Metal components are also generally relatively expensive and introduce costs that must be passed on to the end user.

The industry continues to seek out alternative cart designs that facilitate convenient storage and transportation of purchased articles, while addressing one or more of the above problems.

### SUMMARY OF THE INVENTION

In one form, the invention is directed to a method of transporting articles. The method includes the steps of: providing a cart; placing at least one article in a container/bag having at least one downwardly facing edge; placing the container/bag with the at least one article therein in a hanging position on the cart; and applying a moving force to the frame to reposition the cart with the container/bag thereon. The step of providing a cart involves providing a frame with a top, a bottom, a wheel assembly on the frame and having at least one wheel that can be rolled against an underlying surface, and a hanging assembly. The frame is repositionable between a first storage state and an operative state. With the container/bag in the hanging position, the at least one downwardly facing edge bears against a part of the hanging assembly so that at least a part of the combined weight of the at least one article and container/bag is supported by the hanging assembly. The container/bag with the at least one article therein is suspended above the underlying surface with the frame in the first stored and operative states. The moving force applied to the frame causes the at least one wheel to roll against the underlying surface and the cart and container/bag with the at least one article therein to be repositioned relative to the underlying surface with the cart in the operative state.

The hanging assembly may include an elongate rod that projects in cantilever fashion from the frame.

In one form, the elongate rod has a length and a plurality of discrete receptacles spaced along the length of the elongate rod, each for receiving at least one downwardly facing edge on a container/bag.

The method may further include the step of repositioning the elongate rod relative to the frame between an extended position and a stored position.

In one form, the frame has a receptacle that is configured so that in repositioning the elongate rod between the extended position and stored position, the rod is moved into the frame receptacle.

The cart may further have a graspable handle. The method may include the step of grasping the graspable handle with at least one hand so that the moving force is applied through the graspable handle with the at least one hand grasping the graspable handle.

The frame may have a receptacle for the graspable handle that is moveable between a grasping position and a stored position. As an incident of changing the graspable handle between the grasping position and stored position, the graspable handle is moved into the frame receptacle.

The cart may further include a stabilizing assembly with at least a first stabilizer that abuts to a container/bag in the hanging position to thereby support the container/bag in conjunction with the hanging assembly.

In one form, the frame has a front, a rear, and laterally spaced sides. The elongate rod projects in cantilever fashion rearwardly from the frame. The method may further include the step of repositioning the first stabilizer from a stabilizing position, wherein the first stabilizer projects from the frame in cantilever fashion, into a stored position wherein the first stabilizer is moved from the stabilizing position into the frame receptacle.

The stabilizing assembly may further include a second stabilizer, with the first and second stabilizers projecting in cantilever fashion in opposite directions away from the frame.

The wheel assembly, in one from, consists of first and second spaced wheels between which the frame resides.

In one form, the wheel assembly includes at least one wheel having a rotational axis. The step of repositioning the frame between the first storage state and operative state is effected by moving the frame around the rotational axis.

In one form, the frame has an abutting surface that abuts to the underlying surface to thereby consistently maintain the frame in the first storage state.

In the first storage state, the frame has a vertically extending portion and an offset portion extending rearwardly from the vertically extending portion and defining the abutting surface.

In one form, the front of the frame has a curved shaped where the vertically extending portion blends into the rearwardly extending offset portion. In one form, the frame consists of first and second parts that are relatively repositionable. The method may further include the step of relatively repositioning the first and second frame parts between an assembled state, wherein the frame has a first a vertical dimension with the frame in the first storage state, and a storage state wherein the frame has a corresponding second vertical dimension that is less than the first vertical dimension.

The first and second frame parts may be relatively repositioned by separating the first and second frame parts, each from the other.

The method may further include the steps of releasably securing the first and second frame parts together in the collapsed state.

The cart may include at least one lockable ring for securing an object to the frame.

The frame may have a holder with a receptacle for at least one of: a) cellular telephone; b) a PDA; c) a drinking bottle; and d) a drinking cup.

In one form, the cart frame has a shape that simulates the appearance of an animal with a tail that is defined by the rearwardly extending offset portion.

The frame has laterally spaced sides and a first width between the laterally spaced sides. In one form, the wheel assembly has first and second wheels rotatable around a laterally extending axis and having a second width. The first frame width resides within the second width.

In one form, the second width is not greater than 15 inches.

### BRIEF DESCRIPTION OF THE DRAWINGS

FIG. 1 is a schematic representation of a cart, according to the present invention, and including a frame upon which a hanging assembly and wheel assembly are provided;

FIG. 2 is a flow diagram showing a method of transporting articles in a container/bag using the cart in FIG. 1;

FIG. 3 is a side elevation view of a specific form of cart, as shown in FIG. 1, with the frame shown in one storage state in solid lines and in a second storage state and on operating state separately in dotted lines;

FIG. 4 is a view as in FIG. 3 wherein the hanging assembly and a graspable handle, for repositioning the frame, are shown in solid lines in an operative position and in dotted lines in a stored position;

FIG. 5 is a side elevation view of the cart in the one storage state;

FIG. 6 is a front elevation view of the cart in the one stored position and additionally showing a stabilizer assembly with first and second oppositely projecting stabilizing elements in an operative position;

FIG. 7 is a front elevation view of the cart in the one storage state as in FIG. 6;

FIG. 8 is an elevation view of the cart in the one storage state from the side opposite that in FIG. 5;

FIG. 9 is a plan view of the cart in the one storage state;

FIG. 10 is a view of the cart as in FIG. 5 wherein the hanging assembly, stabilizing elements, and a graspable operating handle are all in stored positions;

FIG. 11 is a front elevation view of the cart with the hanging assembly, stabilizing elements, and graspable handle each in their stored potions;

FIG. 12 is a rear elevation view of the cart wherein the hanging assembly, stabilizing elements, and graspable handle are each in their stored positions.

FIG. 13 is a plan view of the cart wherein the hanging assembly, stabilizing elements, and graspable handle are each in their stored positions;

FIG. 14 is a side elevation view of one type of container/bag that can be placed in a hanging position on the hanging assembly;

FIG. 15 is a view as in FIG. 14 of a modified form of container/bag that can be placed in a hanging position on the hanging assembly;

FIG. 16 is a view as in FIG. 8 wherein frame parts are shown in different relative positions resulting from pivoting movement therebetween to effect collapsing of the cart;

FIG. 17 is a plan view of the cart with the frame parts relatively positioned into a collapsed state;

FIG. 18 is a side elevation view of the cart in the collapsed state of FIG. 17;

FIG. 19 is a view as in FIG. 3 of a modified form of cart made up of separate, joined frame parts;

FIG. 20 is a front elevation view of the cart in FIG. 19;

FIG. 21 is a plan view of the cart with the frame parts separated and rejoined in a collapsible state; and

FIG. 22 is a side elevation view of the cart in FIG. 21 in the collapsible state.

### DETAILED DESCRIPTION OF THE DRAWINGS

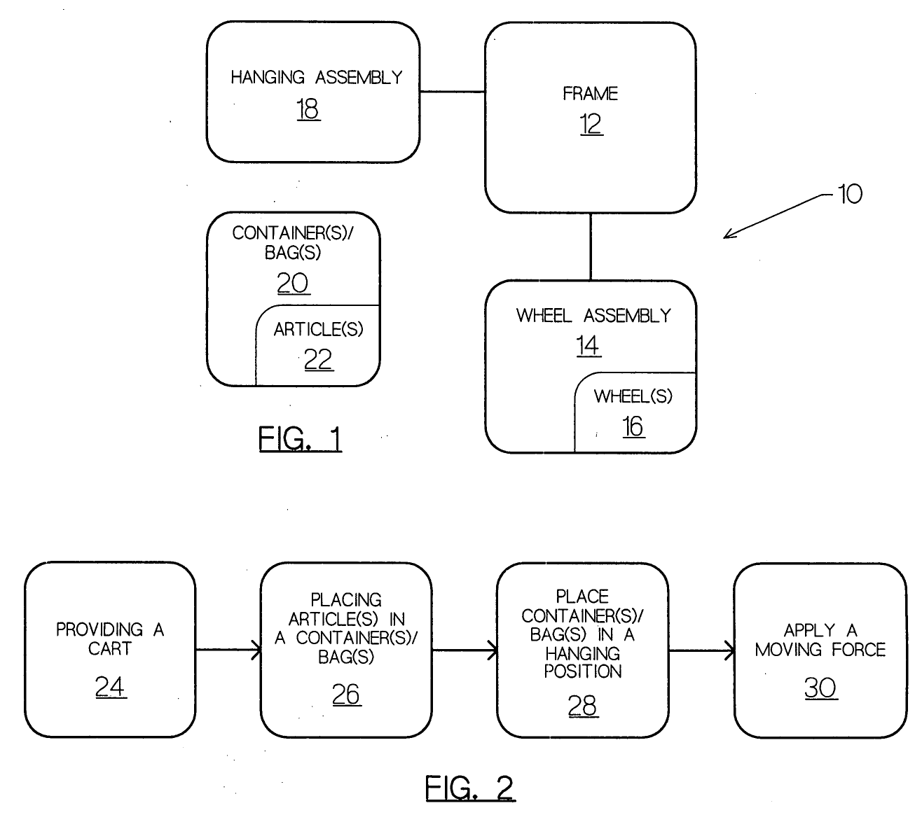

In FIG. 1 a schematic representation of a cart, usable to transport articles according to the present invention, is shown schematically at 10. The cart 10 has a frame 12. A wheel assembly 14, consisting of at least one wheel 16, is provided on the frame 12. A hanging assembly 18 is additionally provided on the frame 12 to support a container/bag 20 with at least one article 22 therein.

The cart 10 is shown schematically in that it is contemplated that virtually a limitless number of different configurations of frame 12, wheel assembly 14, and hanging assembly 18 might be devised consistently with the teachings herein. As just one example, the wheel assembly 14 may consist of a single wheel 16 or two or more wheels 16.

The method of transporting articles, according to the present invention, involves a series of steps, as shown schematically in FIG. 2. As shown at block 24, a cart 10 is provided. As shown at block 26, one or more articles 22 are placed in a container/bag 20. As shown at block 28, the container/bag 20 is placed in a hanging position on the cart 10. The article 22 may be placed in the container/bag 20 before or after it is placed in the hanging position. Finally, as shown at block 30, a moving force is applied to the frame 12 to cause the at least one wheel 16 to roll against an underlying surface and the cart 10 and container/bag 20 with the at least one article 22 therein to be repositioned relative to the underlying surface. This force can be applied through a powered mechanism or directly by a user, as through a user's one hand.

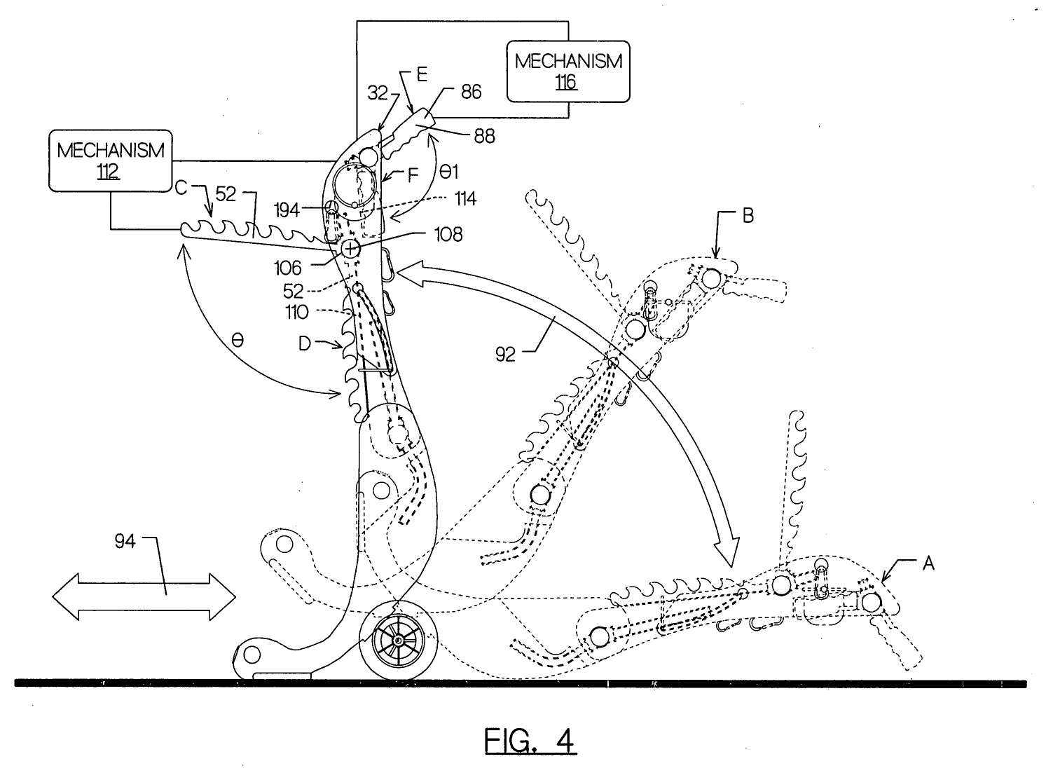

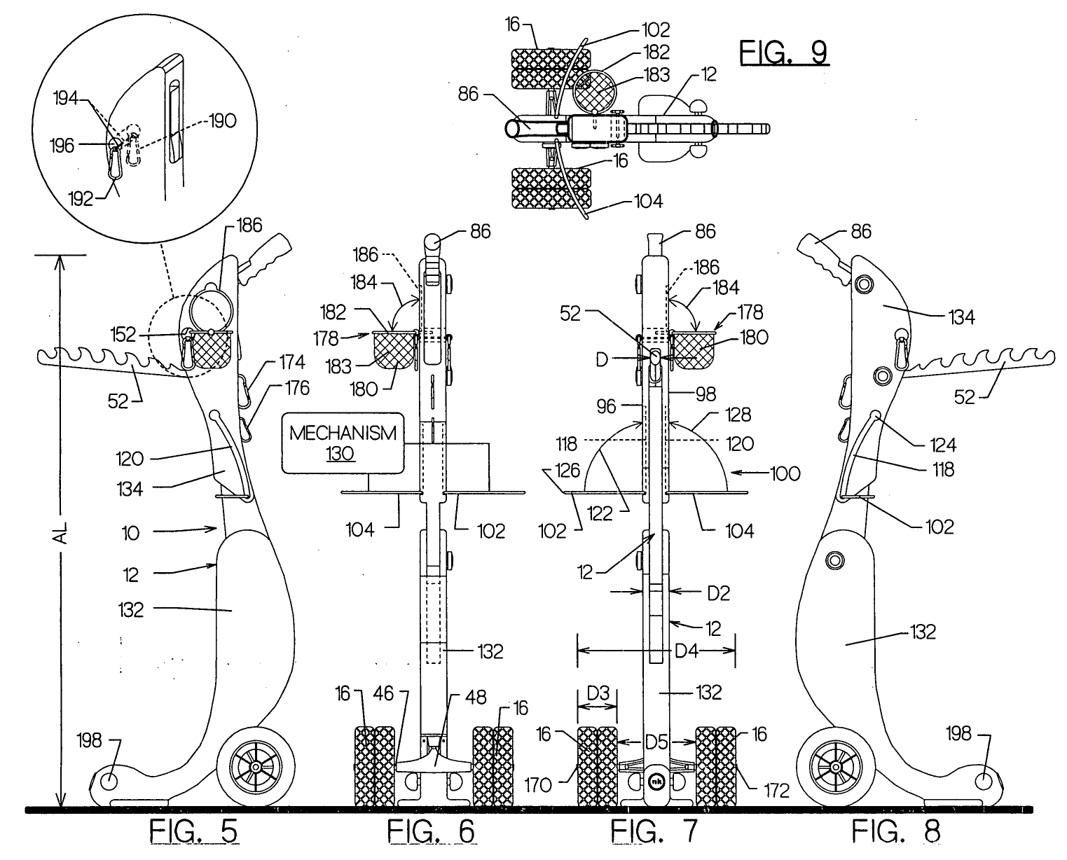

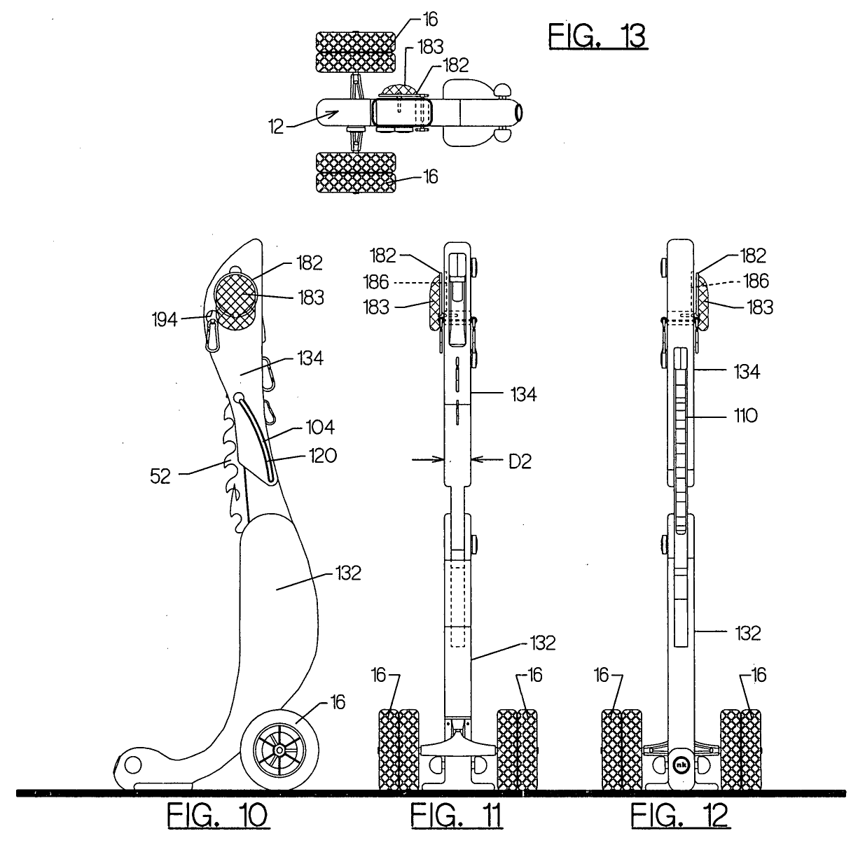

One specific form of the cart 10 is shown in FIGS. 3-13. As noted above, the inventive cart is not limited to the specific configuration shown in these Figures. The cart 10 consists of the aforementioned frame 12 with the associated wheel assembly 14 and hanging assembly 18. As seen in FIG. 3, the frame 12 has two different storage states, as shown in solid lines and in dotted lines at A in FIG. 3. The frame 12 is repositionable from either of the storage states into an operative state, as shown in dotted lines at B in FIG. 3. The operative state actually encompasses a range of different angular positions between those in which the frame 12 is in the separate storage states. In the operative state, the cart 10 is moveable through the wheel assembly 14, as hereinafter described.

The frame 12, in the solid line storage state of FIG. 3, has a top 32 and bottom 34. In the solid line, storage state of FIG. 3, the frame 12 has a vertically extending portion 36 and an offset portion 38 extending rearwardly from the bottom of the vertically extending portion 36. With the frame 12 in the solid line, storage state of FIG. 3, the cart 10 is supported stabily on an underlying surface 40 cooperatively by the wheel assembly 14 and an abutting surface 42 on the rearwardly extending offset portion 38.

The wheel assembly 14 consists, in this embodiment, of a pair of laterally spaced wheels 16 rotatable about a common axis 44 (FIG. 3). The wheels 16 are carried upon an axle 46 that is suspended by a bracket 48 from the frame 12 adjacent to the bottom thereof.

The frame 12 is pivotable about the axis 44 between positions wherein it resides in its operative and separate storage states. With the frame 12 in, or near, the solid line, storage state shown in FIG. 3, the center of gravity of the frame 12 is offset rearwardly from the axis 44 so that the weight of the frame 12 urges the frame around the axis 44 in the direction of the arrow 50 and into the solid line, storage state.

The hanging assembly 18, which is adjacent to the top 32 of the frame 12, consists of an elongate rod 52 that projects in cantilever fashion from the frame 12 in a rearward direction. The elongate rod 52 has a series of upwardly opening, generally U-shaped, discrete receptacles 54 spaced along the length thereof. The number and shape of the receptacles 54 are not critical to the present invention. It is contemplated that each receptacle 54 be capable of accommodating at least one container/bag 20.

More particularly, exemplary containers/bags are shown at 20 and 20′ in FIGS. 14 and 15. The container/bag 20 may be made from any material and has a peripheral wall 58 bounding a storage space 60 for an article 62. The peripheral wall 58 has a cut out 64 through spaced wall portions 66 (one shown) so as to define a downwardly facing edge 68 on each of the wall portions 66. A user directs his/her fingers through the cutouts 64 to surroundingly engage a handle 70 and the edges 68 thereon.

The container/bag 20′ has a similar conventional construction with a peripheral wall 58′ bounding a storage space 60′ for an article 62. Instead of the cut out 64, the container/bag 20′ has a pair of separately attached, U-shaped handles 72 (one shown) which can be surroundingly grasped by a user. In so doing, the user's hand engages a generally downwardly facing edge 74 on each handle 72. The handles 72 and peripheral wall 58′ cooperatively surround an opening 76 through which the user's hand is directed to grasp the handle 72.

In operation, the containers/bags 20, 20′ and cart 10 are relatively repositioned so that the elongate rod 52 projects through the cutout 64 or opening 76, as shown in FIG. 3, whereupon the edges 68, 74 can be placed within one of the receptacles 54, to thereby bear upon an upwardly facing surface 78 bounding the same. Multiple containers/bags 20, 20′ can be placed in each receptacle 54. Alternatively, a single container/bag 20, 20′ can be placed in each of the receptacles 54, whereby the elongate rod 50, in this embodiment, will accommodate six (6) separate container/bags 20, 20′.

Normally, the user will initially place the cart 10 so that the frame 12 is in the solid line, storage state of FIG. 3. The containers/bags 20, 20′ can be suspended from the elongate rod 52 above the underlying surface 40. The user can then pivot the top 32 of the frame 12 forwardly about the axis 44, as indicated by the arrow 80 in FIG. 3, to thereby place the frame 12 in its operative state. Because the front surface 82 of the vertically extending frame portion 36 curves as it blends into the rearwardly extending offset portion 38, a ground clearance region at 84 is defined so that the underlying surface 40 does not interfere with the bottom region of the vertically extending portion 36 of the frame 12 with the frame 12 moved towards, and in, the operative state.

As noted previously, the operative state of the frame 12 includes a range of angular positions therefor between the storage states shown in FIG. 3. The precise angular orientation of the frame 12 selected by a user will be dictated by the user's height as well as the angular preference of the user that facilitates the most comfortable application of the moving force. As can be seen in FIG. 3, with the frame 12 in the operative state, the receptacles 54 open upwardly and slightly rearwardly. By pivoting the frame 12 to the operative state shown at B in FIG. 3, the receptacles 54 open more directly vertically to thereby prevent shifting of any of the associated container/bag edges 68, 74 lengthwise therealong.

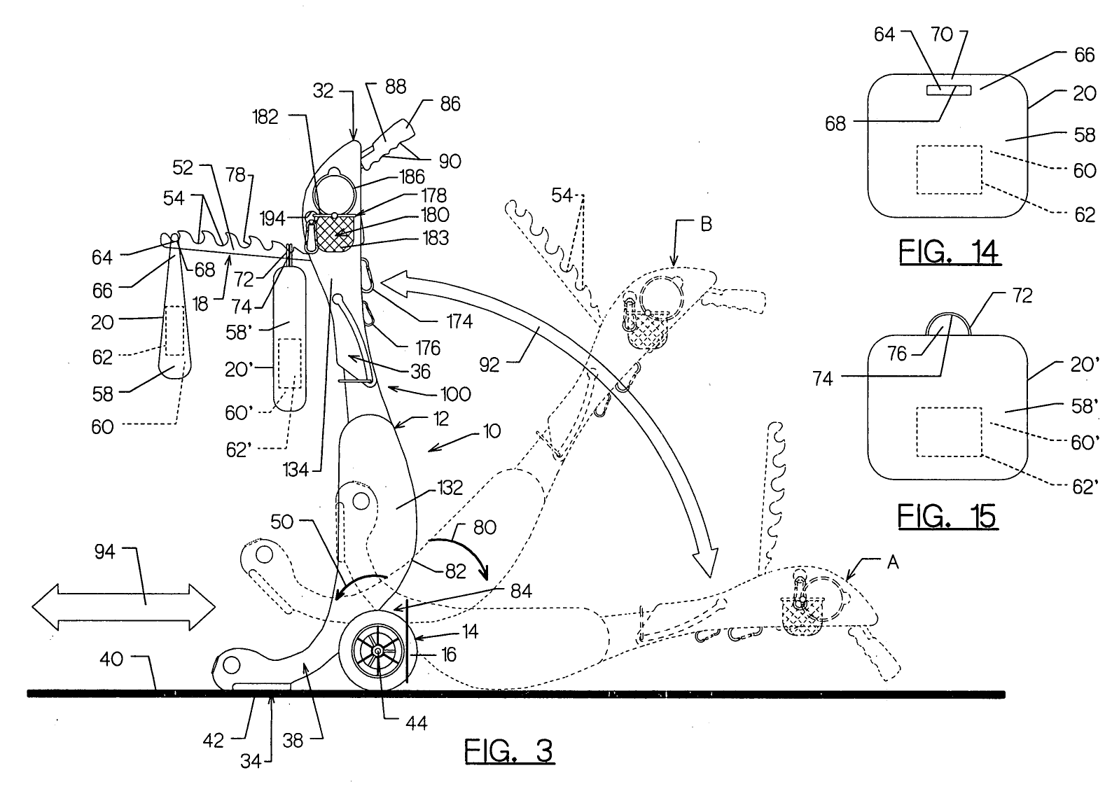

To facilitate repositioning of the frame 12 and movement of the cart 10, a graspable handle 86 is provided at the top 32 of the frame 12 and projects upwardly and forwardly with the frame in the solid line, storage state of FIGS. 3 and 4. In this embodiment, the graspable handle 86 has a body 88 with a generally cylindrical shape, with a series of undercuts 90 to comfortably accept a user's fingers surroundingly engaging the body 88. With the user's hand grasping the handle 86, the frame 12 can be conveniently pivoted around the axis 44 in either direction, as indicated by the arrow 92. Once the frame 12 is pivoted to be in the operative state, a force can be exerted on the frame 12 through the graspable handle 86 to cause the frame to be moved in a fore-and-aft direction, as indicated by the arrow 94, and steered as appropriate. It is contemplated that other types of handles might be utilized, including ones that have a generally horizontally extending gripping length that may accommodate one or both of a user's hands.

Since the elongate rod 52 has a limited lateral dimension D (FIG. 7) between the opposite sides 96, 98 on the frame 12, there may be a tendency of the suspended containers/bags 20, 20′ to shift/rotate around a generally vertically extending axis. To confine this movement, a stabilizing assembly at 100 is provided at a mid-height location upon the frame 12 with the frame in the solid line, storage state of FIG. 3. The stabilizing assembly 100 consists of first and second curved stabilizing elements 102, 104, projecting laterally oppositely in cantilever fashion, respectively from the sides 96, 98 (FIG. 7) of the frame 12, and cooperatively defining a “U” shape opening rearwardly. The height of the stabilizing elements 102, 104 is chosen so that they abut the forwardmost container/bag 20,20′ supported on the elongate rod 52 to limit the aforementioned rotational shifting thereof. Potentially, this shifting could be prevented by a single one of the stabilizing elements 102, 104. Two such stabilizing elements 102,104 are preferred for greater stability and to accommodate larger widths of containers/bags 20, 20′.

With the above-described structure, the user can conveniently load a plurality of containers/bags 20, 20′ in a hanging position upon the hanging assembly 18 with the frame 12 in the solid line storage state of FIG. 3. Thereafter, the user can grasp the handle 86, by applying a force directly thereto, tip the top 32 of the frame 12 forwardly to place the frame 12 in the operative state, and exert either a pushing or pulling force thereupon to cause the wheels 16 to roll against the underlying surface 14 to reposition the cart 10 relative to the underlying surface 40. Through the graspable handle 86 the cart 10 can be conveniently pushed or pulled and steered to change traveling directions.

Additional features of the cart 10, which add further versatility, will now be described. As seen in FIG. 4, the elongate rod 52 may be mounted to the frame 12 through a pin 106 for pivoting movement relative to the frame around a laterally extending axis 108. The elongate rod 52 is selectively pivotable about the axis 108 relative to the frame 12 between an extended position, as shown at C in FIG. 4, and a stored position, as shown at D in FIG. 4, wherein the elongate rod 52 moves at least partially to within a rearwardly opening receptacle 110 at the rear of the frame 12. In this embodiment, a part of the elongate rod 52 remains exposed, for reasons that will be explained hereinafter.

A mechanism 112 is provided, acting between the frame 12 and elongate rod 52, to potentially allow the rod 52 to be releasably fixed in a plurality of different angular positions within the pivoting range identified by the angle θ, which may be on the order of 100°. The mechanism 112 may also releasably lock the elongate rod in the stored position therefor.

A forwardly opening receptacle 114 is provided at the top 32 of the frame 12 to accommodate the graspable handle 86. The graspable handle 86 is selectively pivotable between a grasping position, as shown at E in FIG. 4, and a stored position, as shown at F in FIG. 4, wherein the graspable handle 86 is moved to reside at least partially within the receptacle 114. A mechanism 116, of a type well known to those skilled in the art, can be used to cooperate between the graspable handle 86 and frame 12 to releasably lock the graspable handle 86 in at least the grasping position. Potentially, the mechanism 116 allows the graspable handle 86 to be releasably locked in a plurality of different positions within the pivoting range identified by the angle θ1, which may be on the order of 120°.

Receptacles 118, 120 are provided in the frame 12 and are complementarily curved to match the shape of the stabilizing elements 102, 104 and open laterally oppositely to each accept one of the stabilizing elements 102, 104. Exemplary stabilizing element 102 can be pivoted from its stabilizing position in the direction of the arrow 122 in FIG. 7 through on the order of 90° into a stored position wherein it resides within the receptacle 118. A finger opening 124 is provided at the top of the receptacle 118 to allow the free end 126 of the stabilizing element 102 to be engaged to facilitate the drawing of the stabilizing element 102 from the receptacle 118, to thereby change the stabilizing element 102 from its stored position into its stabilizing position. The stabilizing element 104 is similarly pivotable from its stabilizing position in the direction of the arrow 128 into a corresponding stored position within the receptacle 120.

A suitable mechanism 130, of a type well known to those skilled in the art, may act between at least one of the stabilizing elements 102, 104 and frame 12, thereby releasably maintain the same in the stored and/or stabilizing position and potentially positions therebetween.

By reason of being able to place the elongate rod 52, graspable handle 86 and stabilizing elements 102, 104 each selectively in a stored position, the frame 12 can be compacted, as shown in FIGS. 10-13, primarily to facilitate storage.

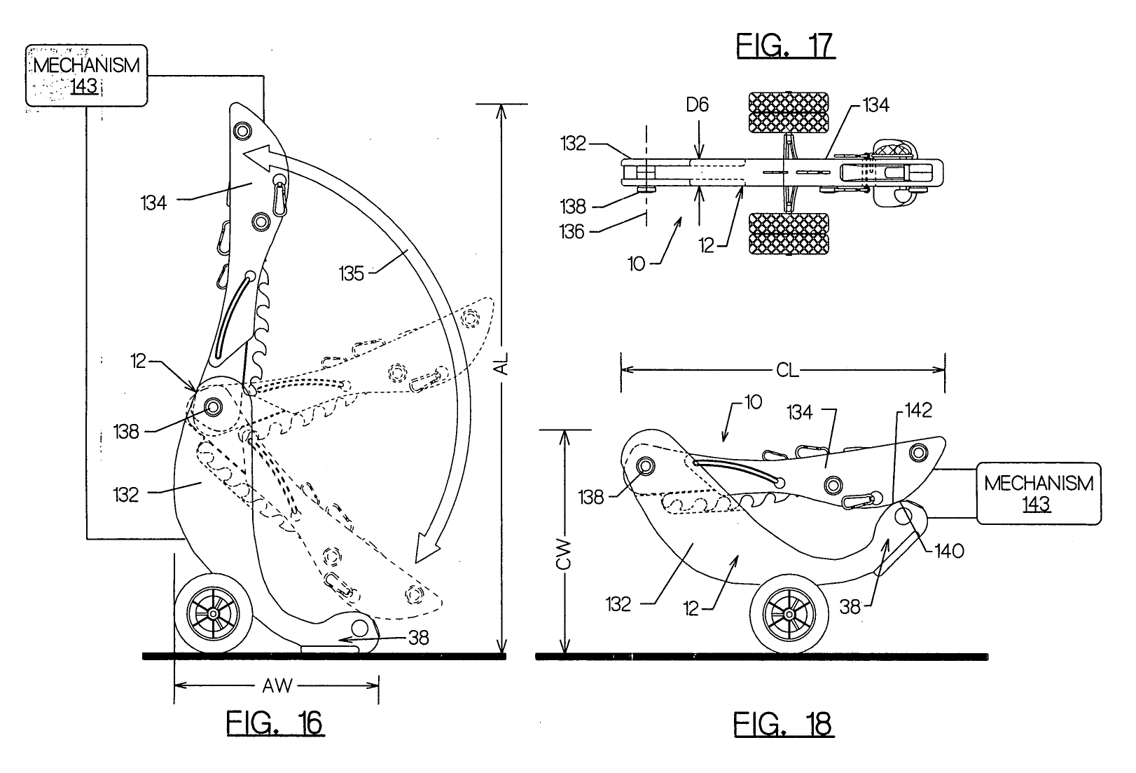

To further compact the cart, the frame 12 can be made with two relatively repositionable parts 132, 134, as seen most clearly in FIGS. 16-18. The frame part 132 is bifurcated to accept the bottom region of the frame part 134. The frame parts 132, 134 may be repositioned relative to each other through guided pivoting movement, as indicated by the double-headed arrow 135.

The parts 132, 134 in are repositionable relative to each other in pivoting movement about a laterally extending axis 136 defined by a pin 138 that engages the lower region of the frame part 134 and upper region of the frame part 136 at a mid-height location on the frame 12 with the frame 12 in the assembled and operative state of FIG. 16. Through this relative pivoting movement, the frame parts can be changed from the assembled state of FIG. 16 into a transitional state as shown also in FIG. 16, and ultimately into a collapsed/storage state, as seen in FIGS. 17 and 18 and in dotted lines in FIG. 16. In the latter state, an edge 140 near the top of the part 134 bears against an edge 142 on the offset portion 38 of the frame 12. One or more conventional-type mechanisms 143 may act between the frame parts 132, 134 to releasably maintain the frame 12 in the assembled state of FIG. 16 and/or the collapsed state of FIGS. 17 and 18.

With the frame 12 in the assembled state of FIG. 16, the frame has an assembled length (AL) and assembled width (AW). In the collapsed/storage state, the frame 12 has a collapsed length (CL) and collapsed width (CW). The collapsed length (CL), with the design shown, is reduced compared to the assembled length (AL) by almost 50%. The collapsed width (CW) is also slightly less than the assembled width (AW). This facilitates transportation of the cart 10 and compact storage thereof.

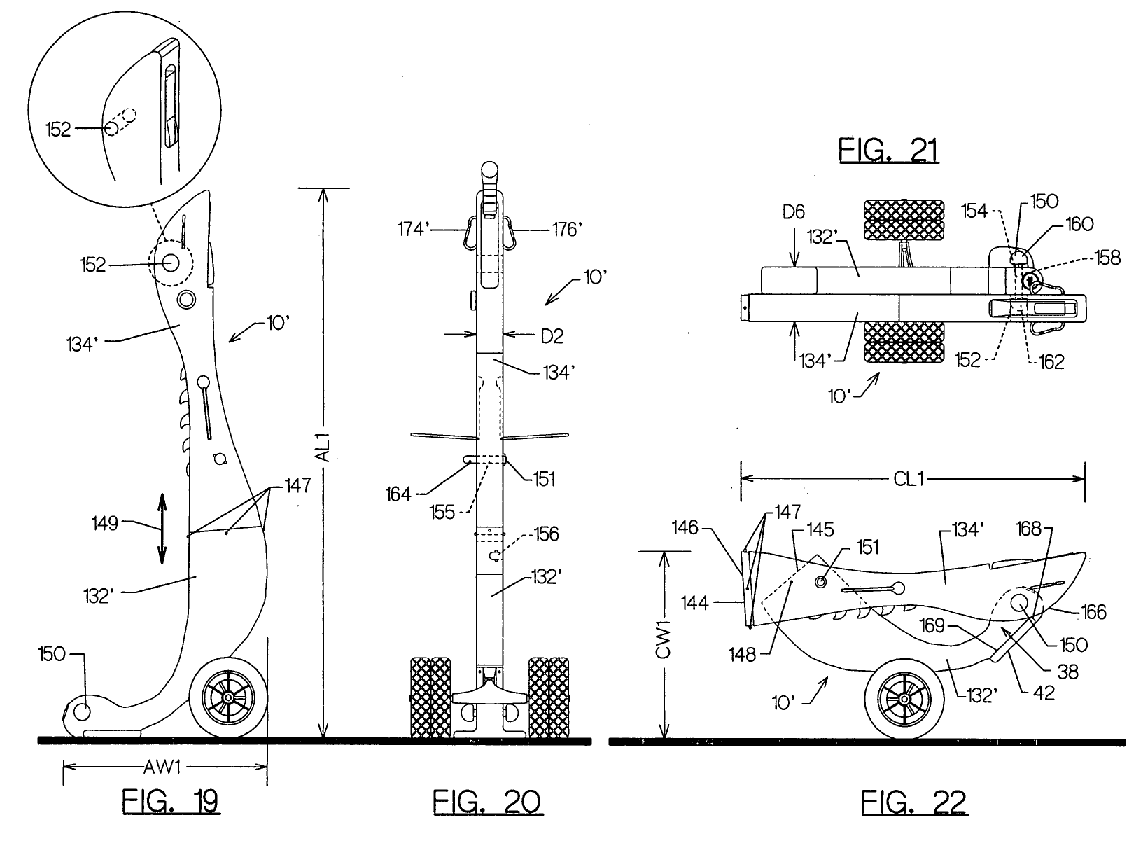

Alternatively, as shown for another embodiment for the cart 10′ in FIGS. 19-22, corresponding parts 132′, 134′ are fully separable, each from the other. To accomplish this, the upper part 134′ has a bottom edge 144 that is telescopingly engaged with a top edge 145 of the bottom portion 132′. In this embodiment, the upper portion 134′ has a male component 146 that is directed into the lower part 132′. However, the arrangement of male and female components could be reversed.

To releasably maintain the connection between the parts 132′, 134′, one or more spring-biased studs 147 are employed. The studs 147 are located on the male component 146 and project through a like number of openings 148 in the lower part 132′. The parts 132′, 134′ are released by depressing the studs 147. With the upper and lower parts 132′ and 134′ connected, the studs 147 are spring-loaded outwardly into the openings 148, thereby to releasably lock the connection of the parts 132′, 134′.

The frame 12′ is collapsed by separating the parts 132′, 134′ through opposite force application along the line of the double-headed arrow 149, which parts thereafter may be releasably joined together in a collapsed/stored/storage state (storage state), as shown in FIGS. 21 and 22. With the parts 132′, 134′ placed in the storage state, this relationship can be maintained through separate pin connectors 150, 151. The pin connector 150, which is normally stored in the rearwardly extending offset portion 38, is removable and reinsertable through aligned openings 152, 154, respectively in the upper and lower frame parts 132′, 134′ with the frame parts 132′, 134′ in their storage state. The stored pin connector 150 functions as a weight stabilizer.

The pin connector 151, normally stored by being directed through a bore 155 in the upper part 134′ as shown in FIG. 20, can be directed through the bore 155 in the upper frame part 134′ and into a blind bore 156 in the lower frame part 132′ with the frame parts 132′, 134′ in the storage state.

The pin connector 150 has a shank 158 with fixed heads 160, 162.

By aligning the head 162 at the opening 152 with the frame parts 132′, 134′ separated, the frame parts 132′, 134′ can be moved towards each other to the FIG. 21 position, wherein the head 162 moves into the slightly larger diameter bore 152 sufficiently that the frame parts 132′, 134′ are keyed by the head 162 against relative pivoting movement about the axis of the pin connector 151. The pin connector 151 releasably maintains the frame parts 132′, 134′ in abutting relationship.

The pin connector 151 has detent elements 164 (one shown in FIG. 20) that may be spring-loaded to releasably maintain the pin connector 151 in place. This connection may be alternatively secured by a threaded or bayonet-type arrangement, or by any other arrangement well known to those skilled in the art.

In the storage state, the rear edge 166 on the frame upper part 134′ bears against a shoulder 168 defined by an enlargement 169 on the rearwardly extending offset portion 38 that defines the abutting surface 42. This further stabilizes the connected parts 132′, 134′ in their storage state. The cart 10′ in FIGS. 19-22 is in most other respects similar to the cart 10.

As seen in FIG. 19, the cart has an assembled length (ALI) and assembled width (AWI) that may be the same as the corresponding dimensions AL, AW for the cart 10 in FIG. 16. In the collapsed/storage state of FIGS. 21 and 22, the cart 10′ has a collapsed length (CLI) and a collapsed width (CWI), with the former significantly less than the assembled length (ALI) and the latter slightly less than the assembled width (AWI). The compacted configuration can be easily stored and transported.

In both embodiments, the frame body has a substantially uniform thickness identified at D2, fully between the top and bottom thereof. Accordingly, the frame 12 can be made compact in nature. As shown from the exemplary cart 10, the wheels 16 each has an axial dimension D3 (FIG. 7) that is on the order of 3 inches. The axial dimension of the entire wheel assembly D4, between the axial outer ends 170, 172 of the separate wheels 16, is on the order of 12 inches, to facilitate maneuvering in tight spaces, such as store aisles. The width D4 may be greater for purposes of stability, but ideally does not exceed 15 inches. In this embodiment, the entire width of the frame 12 resides within the width dimension D5 between the wheels 16, which dimension D5 is on the order of 6 inches. Accordingly, the frame 12 and wheel assembly 14 together have a relatively narrow lateral dimension which makes the same suitable for maneuvering through crowds and in tight spaces, such as store aisles.

The collapsed frame 12, as seen in the storage state in FIG. 17, resides entirely within the width D2.

With the cart 10′ in the storage state, the frame parts 132′, 134′ are placed facially side-to-side to reside within a width dimension D6 that is equal to approximately twice the width dimension D2 and substantially less than the width dimension D5. Thus, the cart 10′ is significantly reduced in its perimeter volume, which represents the minimum volume bounded by spaced and parallel, orthogonal plane pairs within which the cart 10 can be contained.

The frame 12 and parts attached thereto on the cart 10 are uniquely shaped to simulate in this case the appearance of an animal with a tail. That is, the vertically extending portion 36 has a shape that simulates the body of an animal with a head at the top thereof, with the rearwardly extending offset portion 38 simulating the appearance of a tail. By reason of the part of the elongate rod 52 being exposed in its stored position, the receptacles 54 give the appearance of a serrated-type backbone. The opening 152 is strategically located to simulate the appearance of an eye.

For added convenience, additional components may be provided on the frame. For example, locking rings 174, 176 are shown on the frame 12 in vertically spaced relationship to secure in place valuable articles, such as a purse, or the like.

As a still further alternative, a holder, as shown at 178, may be attached to the frame 12 and defines a receptacle 180 conforming to at least one of a cellular telephone, a PDA, a drinking bottle, a drinking cup, or other discrete components. The holder 178 may be fixedly attached or attached to be movable, such as on a swivel connection. In the latter configuration, the holder 178 has a ring 182 which supports a collapsible net 183. The ring 182 is pivotable, as indicated by the double-headed arrow 184, through approximately 90° between the operative position, shown in FIGS. 5-7, and storage position, shown in FIGS. 10-12, wherein the ring 182 seats in a receptacle/undercut 186 on the frame 12. In the operative position, the net 183 opens under its weight to a cup shape. In the storage position, the net 183 collapses compactly against the frame 12.

The frame 12 lends itself to a molded construction from plastic, or a composite. Metal construction, while not preferred, is also contemplated.

As shown in FIGS. 5-7, additional locking rings 190, 192, similar in configuration to those 174,176 previously described, are optimally provided on the cart 10. The locking rings 190, 192 are located on opposite sides of the frame 12 and are interconnected by a semi-rigid/stretchable cord 194 that extends through a bore 196 corresponding to that 152 on the cart 10′. Through this arrangement, the locking rings 174, 176 can each be drawn laterally away from the frame to facilitate connection of an object thereto and disconnection of an object therefrom.

A pin connector 198 on the cart 10 functions similarly to the pin connector 150 as a weight stabilizer 150 on the cart 10′.

The frame and components attached thereto may be configured to selectively simulate the appearance of other animals and may be colored or otherwise adorned to more closely simulate such an animal in appearance.

As noted previously, it is contemplated that only a single wheel 16 might be used. Other structure might be used to stabilize the cart with the frame 12 in its storage position. The single or multiple wheels may be on the order of six inches in diameter. This diameter may be greater or less, depending upon user preference.

Other variations are contemplated consistent with the disclosure herein.

The foregoing disclosure of specific embodiments is intended to be illustrative of the broad concepts comprehended by the invention.

1. A method of transporting articles, the method comprising the steps of:
a) providing a cart comprising:
a frame comprising a top and a bottom,
the frame repositionable between a first stored state and an operative state,
a wheel assembly on the frame and comprising at least one wheel that can be rolled against an underlying surface; and
a hanging assembly;
b) placing at least one article in a container/bag having at least one downwardly facing edge,
the at least one article and container/bag having a combined weight;
c) placing the container/bag with the at least one article therein in a hanging position on the cart wherein the at least one downwardly facing edge bears against a part of the hanging assembly so that at least a part of the combined weight of the at least one article and container/bag is supported by the hanging assembly, whereby the container/bag with the at least one article therein is suspended above the underlying surface with the frame in the first stored and operative states; and
d) applying a moving force to the frame thereby to cause the at least one wheel to roll against the underlying surface and the cart and container/bag with the at least one article therein to be repositioned relative to the underlying surface with the cart in the operative state.

2. A method of transporting articles according to claim 1 wherein the step of providing a cart comprises providing a cart comprising a hanging assembly comprising an elongate rod that projects in cantilever fashion from the frame.

3. A method of transporting articles according to claim 1 wherein the step of providing a cart comprises providing a cart comprising a hanging assembly comprising an elongate rod that projects in cantilever fashion from the frame and has a length and a plurality of discrete receptacles spaced along the length of the elongate rod each for receiving at least one downwardly facing edge on a container/bag.

4. A method of transporting articles according to claim 2 further comprising the step of repositioning the elongate rod relative to the frame between an extended position and a stored position.

5. A method of transporting articles according to claim 2 wherein the step of providing a cart comprises providing a cart comprising a frame with a receptacle and further comprising the step of repositioning the elongate rod relative to the frame between: a) an extended position wherein the elongate rod is exposed outside of the receptacle to allow the container/bag to be placed in the hanging position; and b) a stored position wherein the rod is moved from the extended position into the frame receptacle.

6. A method of transporting articles according to claim 1 wherein the step of providing a cart comprises providing a cart comprising a frame with a graspable handle and further comprising the step of grasping with at least one hand the graspable handle and wherein the step of applying a moving force comprises applying a moving force through the graspable handle with the at least one hand grasping the graspable handle.

7. A method of transporting articles according to claim 6 wherein the step of providing a cart comprises providing a cart comprising a frame with a receptacle and further comprising the step of repositioning the graspable handle relative to the frame between: a) a grasping position wherein the graspable handle is exposed to be grasped by at least one hand of a user; and b) a stored position wherein the graspable handle is moved from the grasping position into the frame receptacle.

8. A method of transporting articles according to claim 1 wherein the step of providing a cart comprises providing a cart comprising a stabilizing assembly comprising a first stabilizer that abuts to a container/bag in the hanging position to thereby support the container/bag in the hanging position in conjunction with the hanging assembly.

9. A method of transporting articles according to claim 8 wherein the step of providing a cart comprises providing a cart comprising a frame with a receptacle and having a front, a rear and laterally spaced sides and a hanging assembly with an elongate rod that projects rearwardly in cantilever fashion from the frame, and further comprising the step of repositioning the frame stabilizer from a) a stabilizing position wherein the first stabilizer projects in cantilever fashion from the frame into b) a stored position wherein the first stabilizer is moved from the stabilizing position into the frame receptacle.

10. A method of transporting articles according to claim 1 wherein the step of providing a cart comprises providing a cart comprising a stabilizer assembly with first and second stabilizers that project in cantilever fashion in opposite directions away from the frame.

11. A method of transporting articles according to claim 1 wherein the step of providing a cart comprises providing a cart comprising a wheel assembly with first and second spaced wheels between which the frame resides.

12. A method of transporting articles according to claim 1 wherein the step of providing a cart comprises providing a cart comprises providing a cart comprising a wheel assembly comprising at least one wheel having a rotational axis and further comprising the step of repositioning the frame between the first stored state and operative state by moving the frame around the rotational axis.

13. A method of transporting articles according to claim 12 wherein the step of providing a cart comprises providing a cart comprising a frame with an abutting surface that abuts to the underlying surface to thereby consistently maintain the frame in the first stored state.

14. A method of transporting articles according to claim 13 wherein the step of providing a cart comprises providing a cart with a frame that in the first stored state has a vertically extending portion and an offset portion extending rearwardly from the vertically extending portion and defining the abutting surface.

15. A method of transporting articles according to claim 14 wherein the step of providing a cart comprises providing a cart with a frame with a front and rear and that has a curved shape at the front of the frame wherein the vertically extending portion blends into the rearwardly extending offset portion.

16. A method of transporting articles according to claim 1 wherein the step of providing a cart comprises providing a cart comprising a frame with first and second parts that are relatively repositionable, and further comprising the step of relatively repositioning the first and second frame parts between an assembled state wherein the frame has a first vertical dimension with the frame in the first stored state and a storage state wherein the frame has a corresponding second vertical dimension that is less than the first vertical dimension.

17. A method of transporting articles according to claim 16 wherein the step of relatively repositioning the first and second frame parts comprises separating the first and second frame parts, each from the other.

18. A method of transporting articles according to claim 17 further comprising the steps of releasably securing the first and second frame parts together in the storage state.

19. A method of transporting articles according to claim 1 wherein the step of providing a cart comprises providing a cart with a frame and at least one lockable ring for securing an object to the frame.

20. A method of transporting articles according to claim 1 wherein the step of providing a cart comprises providing a cart with a frame having a holder with a receptacle for at least one of: a) a cellular telephone; b) a PDA; c) a drinking bottle; d) a drinking cup; and 3) an umbrella.

21. A method of transporting articles according to claim 15 wherein the step of providing a cart comprises providing a cart with a frame that has a shape that simulates the appearance of an animal with a tail that is defined by the rearwardly extending offset portion.

22. A method of transporting articles according to claim 1 wherein the step of providing a cart comprises providing a cart with a frame having laterally spaced sides and a first width between the laterally spaced sides and a wheel assembly with first and second wheels rotatable around a laterally extending axis and having a second width and the first frame width resides within the second width.

23. A method of transporting articles according to claim 22 wherein the step of providing a cart comprises providing a cart with a wheel assembly having a second width that is not greater than 15 inches.
